(19) United States
(12) Patent Application Publication
(10) Pub. No.: US 2004/0205162 A1
(43) Pub. Date: Oct. 14, 2004

(54) Method of executing an edge-enabled application in a content delivery network (CDN)

(76) Inventor: Jay G. Parikh, Redwood City, CA (US)

Correspondence Address: AKAMAI TECHNOLOGIES, INC., ATTN: DAVID H. JUDSON, 8 CAMBRIDGE CENTER, CAMBRIDGE, MA, 02142, US

(21) Appl. No.: 10/411,934

(22) Filed: Apr. 11, 2003

(51) Int. Cl. G06F 15/16

(52) U.S. Cl. 709/219

(57) ABSTRACT

The present invention enables a content provider to outsource its content and application delivery requirements to a content delivery network (CDN), preferably without segmenting its traffic on multiple customer domains. The CDN includes at least a first edge server region having one or more edge servers that serve Web traffic, and at least a second edge server region having one or more edge servers provisioned with an application framework on which edge-enabled applications or application components are executed. A given edge server typically has or can obtain customer-specific metadata identifying how particular file requests are to be processed at that server for the customer. In the context of the present invention, a CDN customer desires to execute a given edge-enabled application, and optionally to serve given Web or streaming media content, preferably from the same customer domain, e.g., www.customer.com. According to the invention, the content is served from a given edge server in the first edge server region, and the edge-enabled application or component thereof is executed in a given edge server in the second edge server region.

### BACKGROUND OF THE INVENTION

1. Technical Field

The present invention relates generally to execution of Web-based applications in a content delivery network.

2. Description of the Related Art

Enterprises can expand their business, increase efficiency, and enable new revenue streams by extending their business applications over the Internet to customers, partners, and suppliers. One way to enable enterprises to shift the operational burden of running a reliable and secure Web presence is to outsource that presence, in whole or in part, to a service provider, such as a content delivery network (CDN). A content delivery network is a collection of content servers and associated control mechanisms that offload work from Web site origin servers by delivering content (e.g., Web objects, streaming media, HTML and executable code) on their behalf to end users. Typically, the content servers are located at the “edge” of the Internet. A well-managed CDN achieves this goal by serving some or all of the contents of a site's Web pages, thereby reducing the customer's infrastructure costs while enhancing an end user's browsing experience from the site. In operation, the CDN uses a request routing mechanism to locate a CDN edge server electronically close to the client to serve a request directed to the CDN. Sites that use a CDN benefit from the scalability, superior performance, and availability of the CDN service provider's outsourced infrastructure.

Many enterprises, such as those that outsource their content delivery requirements, also implement their business services as multi-tier (n-tier) applications. In a representative n-tiered application, Web-based technologies are used as an outer (a first or “presentation”) tier to interface users to the application, and one or more other tiers comprise middleware that provides the core business logic and/or that integrates the application with existing enterprise information systems. The Java 2 Platform, Enterprise Edition (J2EE™) is a technology and an associated component-based model that reduces the cost and complexity of developing such multi-tier, enterprise services. The J2EE runtime environment defines several types of application components that can be used to build services. These include (a) Web tier components (e.g., servlets, JSP pages, Java beans, filters, and web event listeners), which are components that typically execute in a web server and respond to HTTP requests from web clients, and (b) Enterprise tier components (e.g., session beans, entity beans and message driven beans, which may be developed as Enterprise JavaBeans™ (EJB™)), that include the business logic and that execute in a managed environment to support transactions. Runtime support for J2EE application components are provided by so-called “containers,” with a Web container supporting the Web tier components, and an Enterprise container supporting the Enterprise tier components. Containers execute the application components and provide utility services. J2EE-compliant servers provide deployment, management and execution support for conforming application components.

The provisioning of server-side Java applications or application components to run on CDN edge servers presents complex deployment and operational issues. A solution is described in commonly-owned, copending application Ser. No. 10/340,206, filed Jan. 10, 2003, titled “Java Application Framework For Use In A Content Delivery Network.” According to that application, given edge servers in the CDN are provisioned with application server code used to execute Web tier components of an application (an “edge-enabled application”). Even if the CDN service provider operates a suitable application framework such as the framework described in the above-identified application, a customer may still desire to have both its Web content and a given application served from the same domain, such as the customer's World Wide Web (www) domain. This requirement significantly complicates the provisioning and delivery process.

### SUMMARY OF THE INVENTION

The present invention enables a content provider to outsource its content and application delivery requirements to a content delivery network (CDN), preferably without segmenting its traffic on multiple customer domains. The CDN includes at least a first edge server region having one or more edge servers that serve Web traffic, and at least a second edge server region having one or more edge servers provisioned with an application framework on which edge-enabled applications or application components are executed. A given edge server typically has or can obtain customer-specific metadata identifying how particular file requests are to be processed at that server for the customer. In the context of the present invention, a CDN customer desires to execute a given edge-enabled application, and optionally to serve given Web or streaming media content, preferably from the same customer domain, e.g., www.customer.com. According to the invention, the content is served from a given edge server in the first edge server region, and the edge-enabled application or component thereof is executed in a given edge server in the second edge server region.

In a preferred embodiment, the customer domain is associated with a first CDN alias (e.g a#.g.cdnsp.net). A CDN domain name service (DNS) is authoritative for the first CDN alias. As described in U.S. Pat. No. 6,108,703, for example, a CDN DNS associates DNS queries for given domains to given edge server regions, and/or servers within those regions, based on network traffic conditions, network congestion, load, or other metrics. An end user file request directed to the customer domain cues the CDN DNS, which takes the first CDN alias and resolves it to an IP address of a given edge server in the first edge server region. The end user browser then passes a specific file request to the given edge server. The edge server examines the file request using, for example, its customer-specific metadata. If the request is for content, the file request is handled at the edge server, by another edge server in the region, or by going forward to the customer's origin server if needed. If, however, examination of the request indicates that application processing by an edge-enabled application is required, the edge server must redirect the request elsewhere. The default operation of the edge server would be to go forward to another nearby edge server or to the customer origin server. According to the invention, however, this default operation is overridden by metadata, which associates the request with a modified customer domain (e.g., ej.customer.cdnsp.net). If desired, a second CDN alias (e.g., a#.j1.cdnsp.net) may be associated with the modified customer domain. When the edge server goes forward on the modified customer domain (or the second CDN alias), the request is not directed to the origin server; rather, the CDN DNS is cued again, this time resolving the modified customer domain (or the second CDN alias, if used) to a given edge server in the second edge server region, the region that can process edge-enabled applications. If the edge server in the second edge server region has the application component(s) required for processing the specific request, the request is processed, with the results being sent back to the requesting end user. If, however, the edge server in the second edge server region does not have the application component(s) required, the request is then directed (preferably, via an IP tunnel over a back-end LAN) to another edge server in the second edge server region, where it is processed.

The present invention provides significant advantages. Application specific traffic for a given CDN customer need not be segmented by domain, only by path. Web or other content associated with the domain can be served from the first edge server region.

The foregoing has outlined some of the more pertinent features of the present invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference should be made to the following Detailed Description taken in connection with the accompanying drawings, in which:

FIG. 1 is a block diagram of a known content delivery network in which the present invention may be implemented;

FIG. 2 illustrates a typical machine configuration for a CDN edge server;

FIG. 3 illustrates a typical machine configuration for a CDN edge server that is provisioned to executed edge-enabled applications or application components;

FIG. 4 illustrates the mapping of an end user request for execution of an edge-enabled application according to a preferred embodiment of the present invention;

FIG. 5 is a flowchart illustrating the high level processing of an end user request according to the present invention; and

FIG. 6 illustrates a preferred relationship between a first map used for the first CDN alias and a second map, preferably a subset of the first map, used for the second CDN alias.

### DETAILED DESCRIPTION OF THE PREFERRED EMBODIMENT

The present invention leverages Internet CDN architecture and functionality such as generally described below. Familarity with Java programming conventions and the J2EE architecture are presumed. Additional information about J2EE is available in the publication titled Java 2 Platform Enterprise Edition Specification v1.3 (July 2001), which is available from Sun Microsystems.

By way of background, it is known in the prior art to deliver digital content (e.g., HTTP content, streaming media and applications) using an Internet content delivery network (CDN). A CDN is a network of geographically-distributed content delivery nodes that are arranged for efficient delivery of content on behalf of third party content providers. Typically, a CDN is implemented as a combination of a content delivery infrastructure, a DNS request-routing mechanism, and a distribution infrastructure. The content delivery infrastructure usually comprises a set of “surrogate” origin servers that are located at strategic locations (e.g., Internet network access points, Internet Points of Presence, and the like) for delivering content to requesting end users. The request-routing mechanism allocates servers in the content delivery infrastructure to requesting clients in a way that, for web content delivery, minimizes a given client's response time and, for streaming media delivery, provides for the highest quality. The distribution infrastructure consists of on-demand or push-based mechanisms that move content from the origin server to the surrogates. An effective CDN serves frequently-accessed content from a surrogate that is optimal for a given requesting client. In a typical CDN, a single service provider operates the request-routers, the surrogates, and the content distributors. In addition, that service provider establishes business relationships with content publishers and acts on behalf of their origin server sites to provide a distributed delivery system.

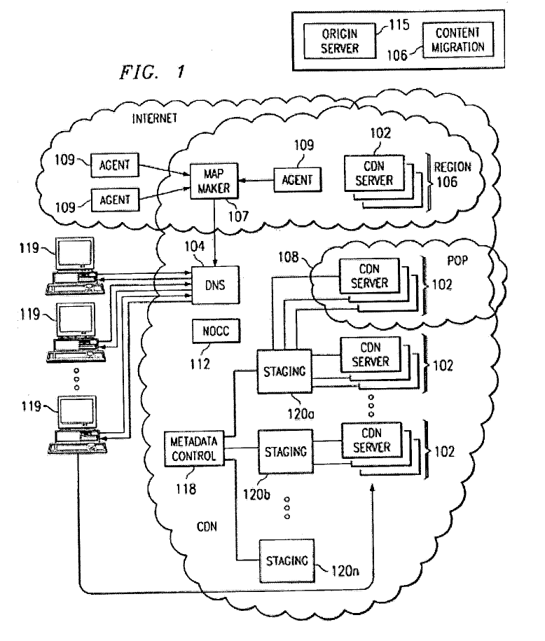

As seen in FIG. 1, an Internet content delivery infrastructure usually comprises a set of “surrogate” origin servers 102 that are located at strategic locations (e.g., Internet network access points, and the like) for delivering copies of content to requesting end users 119. A surrogate origin server is defined, for example, in IETF Internet Draft titled “Requirements for Surrogates in the HTTP” dated Aug. 9, 2000, which is incorporated herein by reference. The request-routing mechanism 104 allocates servers 102 in the content delivery infrastructure to requesting clients. The distribution infrastructure consists of on-demand or push-based mechanisms that move content from the origin server to the surrogates. A CDN service provider (CDNSP) may organize sets of surrogate origin servers as a group or cluster, sometimes called a “region.” In this type of arrangement, a CDN region 106 typically comprises a set of one or more content servers that share a common back-end network, e.g., a LAN, and that are located at or near an Internet access point. A typical CDN region may be co-located within an Internet Service Provider (ISP) Point of Presence (PoP) 108 or some other data center. A “region” need not be associated with or imply any geographic association. A representative CDN content server is a Pentium-based caching appliance running an operating system (e.g., Linux-based, Windows NT, Windows 2000) and having suitable RAM and disk storage for CDN applications and content delivery network content (e.g., HTTP content, streaming media and applications). Such content servers are sometimes referred to as “edge” servers as they are located at or near the so-called outer reach or “edge” of the Internet. An “edge” server need not be associated with or imply any particular geographic association, however. The CDN typically also includes network agents 109 that monitor the network as well as the server loads. These network agents are typically co-located at third party data centers or other locations. Mapmaker software 107 receives data generated from the network agents and periodically creates maps that dynamically associate IP addresses (e.g., the IP addresses of client-side local name servers) with the CDN regions.

Content may be identified for delivery from the CDN using a content migrator or rewrite tool 106 operated, for example, at a participating content provider server. Tool 106 rewrites embedded object URLs to point to the CDNSP domain. A request for such content is resolved through a CDNSP-managed DNS to identify a “best” region, and then to identify an edge server within the region that is not overloaded and that is likely to host the requested content. Instead of using content provider-side migration (e.g., using the tool 106), a participating content provider may simply direct the CDNSP to serve an entire domain (or subdomain) by a DNS directive (e.g., a CNAME). In either case, the CDNSP may provide object-specific metadata to the CDN content servers to determine how the CDN content servers will handle a request for an object being served by the CDN. Metadata, as used herein, refers to a set of control options and parameters for the object (e.g., coherence information, origin server identity information, load balancing information, customer code, other control codes, etc.), and such information may be provided to the CDN content servers via a configuration file, in HTTP headers, or in other ways. The Uniform Resource Locator (URL) of an object that is served from the CDN in this manner does not need to be modified by the content provider. When a request for the object is made, for example, by having an end user navigate to a site and select the URL, a customer's DNS system directs the name query (for whatever domain is in the URL) to the CDNSP DNS request routing mechanism. Once an edge server is identified, the browser passes the object request to the server, which applies the metadata supplied from a configuration file or HTTP response headers to determine how the object will be handled.

As also seen in FIG. 1, the CDNSP may operate a metadata transmission system 116 comprising a set of one or more servers to enable metadata to be provided to the CDNSP content servers. The system 116 may comprise at least one control server 118, and one or more staging servers 120a-n, each of which is typically an HTTP server (e.g., Apache). Metadata is provided to the control server 118 by the CDNSP or the content provider (e.g., using a secure extranet application) and periodically delivered to the staging servers 120a-n. The staging servers deliver the metadata to the CDN content servers as necessary. Of course, any other convenient data transport mechanism may be used to deliver the customer metadata to the CDN servers.

FIG. 2 illustrates a typical machine configuration for a CDN edge server. Typically, the content server 200 is a caching appliance running an operating system kernel 202, a file system cache 204, server manager software 206, TCP connection manager 208, and disk storage 210. Server manager software 206, among other things, creates and manages a “hot” object cache 212 for popular objects being served by the CDN. It may also provide other CDN-related functions, such as request routing, in-region load balancing, and the like. In operation as an HTTP cache for example, the content server 200 receives end user requests for content, determines whether the requested object is present in the hot object cache or the disk storage, serves the requested object via HTTP (if it is present) or establishes a connection to another content server or an origin server to attempt to retrieve the requested object upon a cache miss. Typically, the edge server operates in a “pull” manner, wherein an object is pulled into the cache initially upon the first request to the cache—which will generate a cache miss since the object is not present. This is not required, however, as content may be pushed into the server before it is requested for the first time.

The CDN also includes an application framework comprising, for example, at least one region of application server-enabled edge servers. In such case, a given edge server (the machine) such as illustrated above in FIG. 2 also includes application server code. As is well-known, an application server is a software platform (sometimes called middleware) on which applications can be deployed. It provides useful utility services and functions to applications. There are currently several major types of application servers, Java-based (J2EE) and Microsoft NET. Java, of course, is a programming language and a platform, and the programming language is object-oriented and platform independent. Applications written in Java are translated into Java byte code, which code is then run on (intepreted by) a Java Virtual Machine (JVM). In one embodiment, the present invention takes advantage of given edge servers in the CDN that are provisioned with application server and additional code to enable applications or application components to be executed from the edge of the Internet. The framework can take advantage of and leverage the mapping, load-balancing and management systems used with known CDN offerings, such as the CDN illustrated in FIG. 1 (which is merely representative). In a first embodiment, the application server is a servlet container (e.g., Apache Tomcat), to enable offloading and execution of the Web tier of n-tier Java-based applications. JSP, servlets, Java beans and custom tags, which are executed within an application server's servlet container, are executed at the edge of the Internet, close to the end-user. The Web tier is typically the front end of a J2EE server. In an alternate embodiment, in addition to the Web tier, at least some or all of the Enterprise tier of the application is also deployed to and executed on a given edge server. The Enterprise or “business” tier typically hosts application-specific business logic and provides system-level services such as transaction management, concurrency control, and security. Further details of a preferred Java-based application framework are described in copending, commonly-owned Ser. No. 10/304,206, the disclosure of which is incorporated by reference.

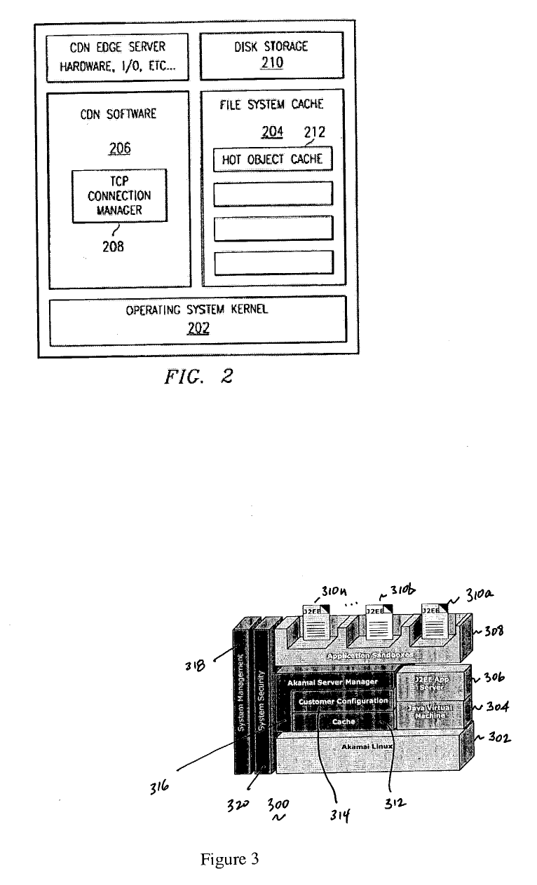

FIG. 3 illustrates a representative edge server architecture for a CDN server in the edge-enabled application region(s). A given region includes one or more of such servers that are interconnected over a common back-end LAN, as previously described. The server 300 preferably runs on commodity hardware running an operating system (e.g., a modified form of Linux) 302. The Java stack includes a Java Virtual Machine (JVM) 304 and preferably a J2EE-compliant application server 306. For Web tier components, the application server 306 may be implemented with Apache Tomcat servlet container. In particular, a representative Web container is provided by Apache Tomcat servlet container, which uses the JVM in JDK 1.3.1_{—}04 available from Sun Microsystems. Of course, these components are merely exemplary and are not meant to be limiting. For Web tier and Enterprise tier components, the application server 306 may be implemented with IBM WebSphere Application Server (WAS), such as Version 5.0 application server (WAS). IBM WebSphere uses JVM (Java Virtual Machine) 1.3.1. These products, of course, are merely exemplary. The framework (preferably the JVM) creates and maintains application sandboxes 308 for each of the applications 310a-n. A given customer may run application 310a, while another customer runs application 310b. Generalizing, the edge server 300 supports one or more discretely-executable applications. The edge server 300 implements a cache 312 and maintains customer configuration data 314 that controls when application components are used. The server manager 316 overlays and controls the cache, using the customer configuration data. System management 318 and system security 320 modules are also provided to facilitate these and other functions.

A CDN customer may desire to have both its Web content and a given application served from the same domain, such as the customer's World Wide Web (www) domain, or one or more associated sub-domains. The present invention addresses this requirement, enabling application specific traffic to be served (by the CDN) even if the applications (or application components) necessary for that traffic are associated with the same domain that is used for content delivery. The present invention thus enables a content provider to outsource its content and application delivery requirements to a content delivery network (CDN), preferably without segmenting its traffic on multiple customer domains.

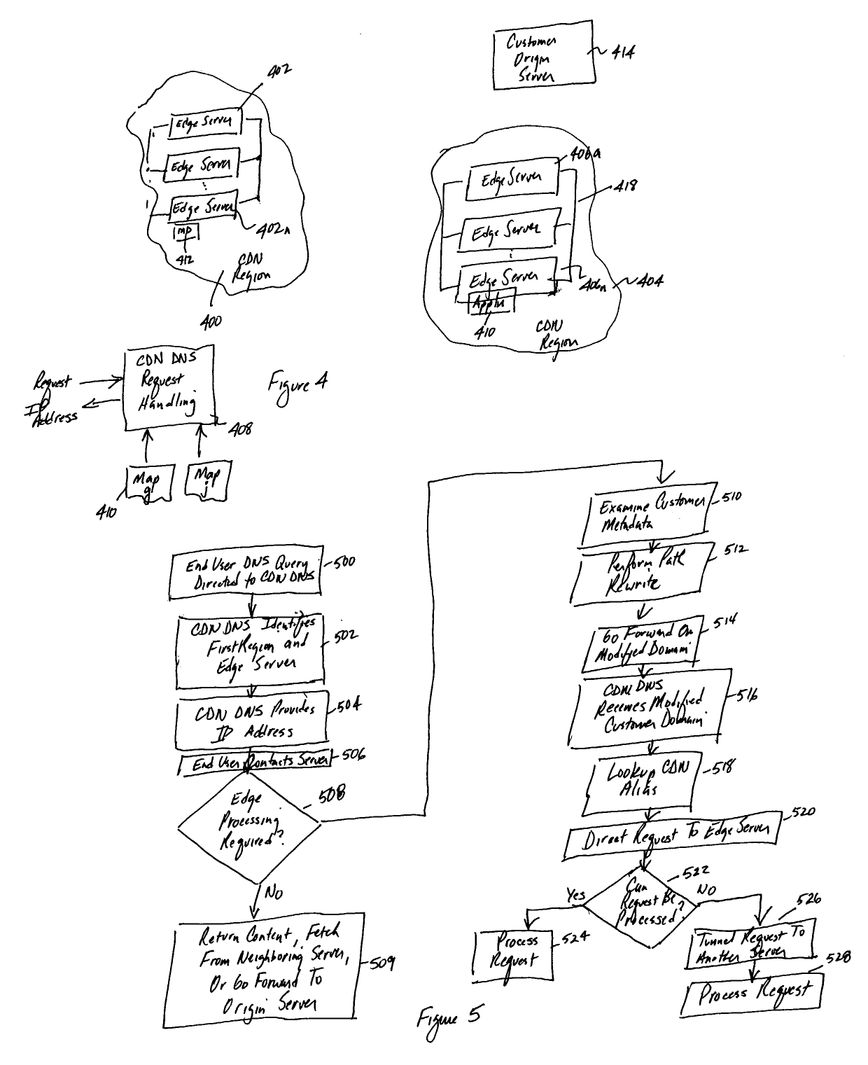

As illustrated in FIG. 4, the CDN includes at least a first edge server region 400 having one or more edge servers 402a-n that serve Web traffic, and at least a second edge server region 404 having one or more edge servers 406a-n provisioned with an application framework on which edge-enabled applications or application components are executed. A given edge server 402 is illustrated in FIG. 2, and a given edge server 406 is illustrated in FIG. 3. As noted above, a given edge server also typically has or can obtain customer-specific metadata identifying how particular file requests are to be processed at that server for the customer. In the context of the present invention, a CDN customer desires to execute a given edge-enabled application, and optionally to serve given Web or streaming media content, preferably from the same customer domain, e.g., www.customer.com. The present invention is not limited to a single domain, although this will be a preferred implementation. According to the invention, the content is served from a given edge server 402 in the first edge server region 400, and the edge-enabled application or component thereof is executed in a given edge server 406 in the second edge server region 404.

In a preferred embodiment, the customer domain is associated with a first CDN alias (e.g a#.g.cdnsp.net). A CDN domain name service (DNS) is authoritative for the first CDN alias. As described in U.S. Pat. No. 6,108,703, for example, a CDN DNS mechanism 408 associates DNS queries for given domains to given edge server regions, and/or servers within those regions, based on network traffic conditions, network congestion, load, or other metrics. A map 410 (referred to as the “g” map in this example) is used for this purpose. An end user file request directed to the customer domain cues the CDN DNS mechanism 408, which takes the first CDN alias and, using the g map 410, resolves it to an IP address of a given edge server 402 in the first edge server region 400. Of course, while only one region 400 is illustrated in the drawing, one of ordinary skill in the art will appreciate that the CDN typically includes many such regions, as was illustrated above in FIG. 1. Resolution of the DNS query using the “g” map may direct an end user to any of such regions. Once the end user has been mapped to the edge server region, in this example region 400, the end user browser then passes a specific file request to the given edge server.

The edge server 402 examines the file request using its customer-specific metadata 412. If the request is for content, the file request is handled at the edge server, by another edge server in the region, or by going forward to the customer's origin server 414 if needed. If, however, examination of the request indicates that application processing by an edge-enabled application is required, the edge server 402 must redirect the request elsewhere. The default operation of the edge server would be to go forward to another nearby edge server (typically in the region) or to the customer origin server 414.

The need for application processing typically is determined by performing a URI path match on the file request, which is delivered from the end user client browser to the identified edge server in the first edge region. As is well known, a request for application processing may include a path such as “. . . /java/index jsp” (for a Java-based application) or the like, which triggers the path match. Of course, the particular type of path match will depend on the application component to be executed, and the above file match semantic is merely illustrative.

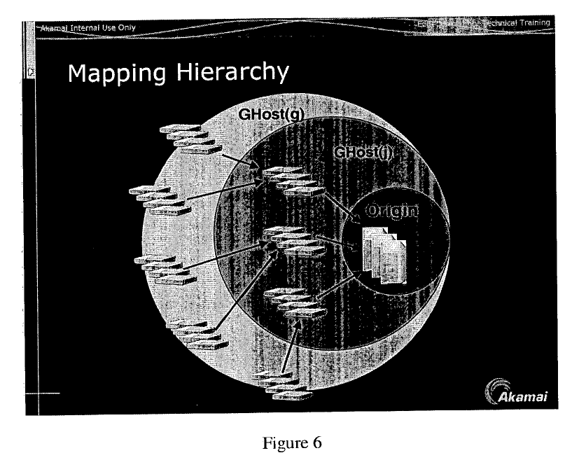

According to the invention, the default “go forward” operation of the edge server is overridden by metadata, which preferably associates the file request (in this case, . . . /java/index jsp) with a modified customer domain (e.g., ej.customer.cdnsp.net). As an optimization, and for the reasons described below, a second CDN alias (e.g., a#j1.cdnsp.net) may be associated with the modified customer domain, although this is not required. Then, when the edge server goes forward on the modified customer domain (or the second CDN alias, if it is used), the request is not directed to the origin server or some other server in the first edge region; rather, the CDN DNS mechanism 408 is cued again, this time resolving the modified customer domain (or the second CDN alias, if it is used) to a given edge server in the second edge server region, or any CDN region that can process edge-enabled applications. In a preferred embodiment, a map 416 (referred to as the “j1” map in this example) is used to locate an edge server in the second edge region for handling the processing of the application processing. The mapping preferably locates an edge server 406 in the second edge region 404 that has instantiated the application or application component and is not overloaded. As illustrated in FIG. 6, preferably the j1 map 416 is a subset of the g map 410, although this is not a requirement.

If the edge server 406 to which the request has been directed (by the CDN DNS mechanism 408) has the application component(s) 410 required for processing the specific request, the request is processed, with the results being sent back to the requesting end user. If, however, the edge server (in this case server 406b) does not have the application component(s) required, or if that machine cannot process the request for some reason, such as excessive latency or load, the request is then directed (preferably, via an IP tunnel over a back-end LAN 418) to another edge server (e.g., server 406a) in the second edge server region. The request is then processed in this alternative edge server in the second edge region.

The use of a second CDN alias is not required, as noted above. Rather, the edge server in the first edge server region may simply map the modified customer domain (e.g., ej.customer.cdnsp.net) to a preferred second edge region using the CDN DNS mechanism. The use of a second CDN alias is an optimization, and it is desirable because the same modified customer domain may be used in the customer metadata while enabling the CDN service provider to modify the mappings dynamically (e.g., by altering the associations of end user local name servers to CDN edge servers as defined in the j1 map).

One of ordinary skill will appreciate that the present invention enables application specific traffic to be served from the same domain used by a content provider to serve other content (e.g., Web content, streaming media, application downloads). Application specific traffic not be segmented only by path, and not necessarily by domain, which greatly simplifies the CDN customer integration process. Web or other content associated with the customer domain can be served from the first edge server region, while a given edge-enabled application executes in the second edge server region. To facilitate this operation, the edge server in the first region includes appropriate software routines to store and manage customer specific metadata, to interpret such metadata, to evaluate whether a given request requires application processing, to “go forward” on another DNS name, and, if necessary, to perform a forward path rewrite to a modified customer domain identified in the customer metadata. As has been described, the forward path rewrite to the modified customer domain is used to cue the CDN DNS. As has also been described, the edge server may also have the capability to associate a second CDN alias to the modified customer domain and to go forward to the CDN DNS on the second CDN alias.

FIG. 5 is a flowchart illustrating the preferred method of executing an edge-enabled application in the CDN. As noted above, it is assumed that a set of one or more CDN regions are associated with a first map (e.g., the “g” map) and a set of one or more CDN regions are associated with a second map (e.g., the “j1” map), which may be a subset of the first map. This relationship between the “g” map and “j1” map is illustrated, by way of example only, in FIG. 6. At step 500, an end user DNS query (e.g., to a#.g.cdnsp.net) is directed (typically from an end user's local name server) to the CDN DNS. At step 502, CDN DNS identifies a first region and a given edge server in that region. At step 504, CDN DNS provides the requesting edge server with an IP address of that server. At step 506, the end user browser contacts the edge server in the first region, typically with a specific file request. A test is then performed at step 508 to determine if a directory or file match on that request indicates a need for edge processing. If the outcome of the test at step 508 is negative, the request is processed by the edge server in the usual manner, e.g., by returning the requested content (if it is cached), by fetching the content from another edge server in the region (e.g., using ICP), or by going forward to fetch it from an origin server or other location. This default operation is step 509.

If, however, the result of the test at step 508 indicates a match, which is indicative of the need for edge processing, the edge server examines the customer metadata at step 510, performs a forward path rewrite 512 to a modified customer domain (e.g., ej.customer.cdnsp.net) identified in that metadata, and then goes forward 514. At step 516, the CDN DNS receives the modified customer domain. If the modified customer domain has been aliased through a CNAME (or the like), the CDN DNS looks up an associated CDN alias (e.g., a#.j1.cdnsp.net) at step 518. This operation identifies an edge server in the second edge region, which as noted above is the region that includes application server-enabled edge servers. At step 520, the request is directed to an edge server in that region. At step 522, a test is performed to determine if the request can be processed at the edge server to which the end user's browser has been mapped. If so, the request is processed at step 524, and the results returned. If, however, the result of the test at step 522 indicates that the edge server cannot process the request, the request is directed to another edge server in the region. This is step 526. Preferably, the request is directed via an IP tunnel over a backend network that is shared by the edge servers. IP tunneling of the request is not required, however. After the request is passed, the routine continues at step 528, with the request being processed and the results returned. In this manner, the end user is able to obtain application-specific processing from the second edge server region. That end user may also obtain Web or other content from a given edge server in the first region. There is no limitation as to the particular type of application component that may be implemented and deployed as an edge-enabled CDN application. Representative applications include, without limitation, product configurators, dealer locators, contest engines, content transcoders, content generators, search aggregators, financial calculators, registration engines, and a myriad of others.

One of ordinary skill will recognize that many variants are within the scope of the present invention. Thus, for example, there is no requirement that the second edge server region be associated with a given first edge server region. Typically, a second edge server region, i.e., the region that enables the application processing, is associated with several Web content “first” regions. Of course, the number and placement of regions will depend on the load. Moreover, there is no requirement that both the Web content and the edge-enabled application-specific traffic be associated with a single top level customer domain, as has been illustrated. The inventive functionality may be implemented with respect to a sub-domain, such as subdomain.customer.com, or some other domain identifier. A given application running in the second edge server region may execute in a standalone manner completely as an edge-enabled application, or portions of that application may run elsewhere (e.g., the customer's origin server). There is no requirement that application components be loaded only in response to client requests at a particular edge server. Indeed, in many cases it will be desirable to pre-deploy an application or an application component based on some prediction of expected future need for that application or component, or for purposes of fault tolerance. Thus, a given application or component thereof may be delivered to a particular edge server and initialized and started irrespective of whether an end user request has been received at the server. Also, there is no requirement that application components be fully or partially J2EE-compliant, or even that the subject matter be implemented entirely in Java. Indeed, the present invention is also extensible beyond Java and J2EE. In particular, the inventive concepts may be practiced in any platform-independent application server programming environment (e.g., Microsoft .NET, Mod Perl executing in Apache, Zope, or the like) capable of being deployed in a distributed computing environment such as a content delivery network.

Having described my invention,

What I claim is as follows:

1. A method operative in a content delivery network, the CDN having a domain name service (DNS) authoritative for given CDN domains, at least a first edge server region having one or more edge servers that serve content, and a second edge server region having one or more edge servers provisioned with an application framework on which edge-enabled applications or application components may be executed, comprising:
responsive to a DNS query to a first domain, having the CDN DNS identify a given edge server in the first edge server region;
at the given edge server in the first edge server region, receiving a request;
determining whether application processing is required to service the request;
if application processing is required to service the request, having the given edge server in the first edge server region issue a DNS query to a second domain;
responsive to the DNS query to the second domain, having the CDN DNS identify a given edge server in the second edge server region; and
attempting to process the request at the given edge server in the second edge server region.

2. The method as described in claim 1 further including the steps of:
determining whether the given edge server in the second edge server region can process the request; and
if the given edge server in the second edge server region can process the request, executing a given application component, and returning a response to the request;
if the given edge server in the second edge server region cannot process the request, directing the request to another edge server in the second edge server region.

3. The method as described in claim 2 wherein the step of determining evaluates whether the given edge server in the second edge server region has a given edge-enabled application available for execution.

4. The method as described in claim 2 wherein the request is directed by IP tunneling the request over a backend network shared by the edge servers in the second edge server region.

5. The method as described in claim 1 wherein the first domain is a customer domain.

6. The method as described in claim 5 wherein the second domain is a modified customer domain.

7. The method as described in claim 5 wherein the second domain is a domain uniquely associated with a CDN edge-enabled application processing map.

8. A method operative in a content delivery network, the CDN having a domain name service (DNS) authoritative for given CDN domains, at least a first edge server region having one or more edge servers that serve content, and a second edge server region having one or more edge servers provisioned with an application framework on which edge-enabled applications or application components may be executed, wherein the CDN DNS identifies a given edge server in the first edge server region in response to a DNS query to a customer domain, comprising:
at the given edge server in the first edge server region, receiving a file request;
determining whether application processing is required to service the file request;
if application processing is required to service the file request, identifying a given edge server in the second edge server region; and
attempting to process the request at the given edge server in the second edge server region.

9. The method as described in claim 8 wherein the step of identifying a given edge server in the second edge server region includes the steps of:
executing a forward path rewrite to a modified customer domain; and
having the CDN DNS map a query to the modified customer domain to identify the given edge server in the second edge server region.

10. The method as described in claim 8 further including the step of:
if application processing is not required to service the file request, serving given content from the given edge server in the first edge server region.

11. A method operative in a content delivery network, the CDN having an authoritative domain name service (DNS), at least a first server region having one or more servers that serve content, and a second server region having one or more servers provisioned with an application framework on which edge-enabled applications or application components are executed, comprising:
having the CDN DNS resolve queries to a single customer domain to the first server region;
servicing requests for content in the first server region, or from an alternative source;
re-directing requests for application processing from the first server region to the second server region; and
servicing requests for application processing in the second server region.

12. The method as described in claim 11 wherein the requests for content include requests for Web content, streaming media, or an executable.

13. The method as described in claim 11 further including the step of determining whether a given file request requires application processing;
if the given file request requires application processing, associating the request with a given CDN domain;
resolving the given CDN domain to identify a given server in the second server region.
